(19) United States
(12) Patent Application Publication
(10) Pub. No.: US 2024/0207832 A1
(43) Pub. Date: Jun. 27, 2024

(54) PHOTOCATALYST COATING LIQUID

(71) Applicant: SHARP KABUSHIKI KAISHA, Osaka (JP)

(72) Inventors: Yoshiki KATO, Osaka (JP); Naoki SHIBA, Osaka (JP); Yoshitaka KAWASE, Osaka (JP); Tomoya TSUTSUMINO, Osaka (JP); Tatsufumi ATSUMI, Osaka (JP)

(21) Appl. No.: 18/534,331

(22) Filed: Dec. 8, 2023

(30) Foreign Application Priority Data
Dec. 21, 2022 (JP) 2022-204621

(51) Int. Cl. B01J 35/39; B01J 23/30; B01J 31/04; B01J 31/34

(52) U.S. Cl. CPC B01J 35/39; B01J 23/30; B01J 31/04; B01J 31/34

(57) ABSTRACT

A photocatalyst coating liquid of the present disclosure includes a visible light-responsive photocatalyst particle containing tungsten oxide, a water-soluble copper compound, and an aqueous medium. The photocatalyst coating liquid has a hue of green, blue-green, or blue, and the hue belongs to a region of 5G to 10B on the hue wheel of the Munsell color system.

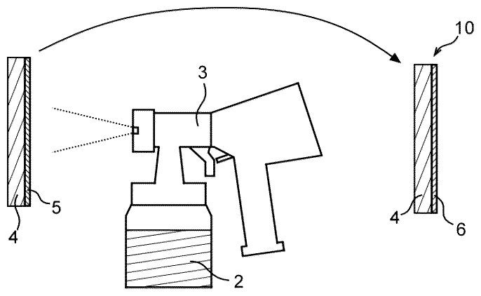

### BACKGROUND OF THE INVENTION

### Field of the Invention

The present disclosure relates to a photocatalyst coating liquid.

### Description of the Background Art

Forming a visible light-responsive photocatalyst coating layer on a base material can cause effects such as removal of a volatile organic compound (VOC) and antibacterial/antiviral properties in a weak lighting environment such as indoor. Further, various methods have been devised to reliably form the coating layer on the base material by applying the coating liquid including the photocatalyst.

According to the prior art, it is known that an organic pigment is compounded in the coating liquid for photocatalyst film to improve visibility and confirm formation of the photocatalytic film. The organic pigment is decolorized by the photocatalytic effect after application. According to the prior art, it is known that excellent visibility is obtained through light during application by including a photocatalyst particle, a specific basic pigment, and a clay-based stabilizer.

However, these methods are intended to increase visibility by attaching the pigment to the coated area, thereby easily distinguishing the coated area from the uncoated area based on the difference in appearance. Further, the basic pigment such as methylene blue fades under visible light illumination, making these methods unsuitable for coating without deteriorating the aesthetic appearance of the base material.

A titanium oxide-based photocatalyst has a white color, and a tungsten oxide-based photocatalyst has a pale yellow to green-yellow color. When such a photocatalyst is applied in a large amount on a base material with a different color tone, such as blue, to form a photocatalyst coating layer, the color of the base material and the color of the photocatalyst coating layer mix, resulting in deterioration of the aesthetic appearance of the base material. It may be conceivable to obtain a desired color tone by combining a photocatalyst and a coloring agent. However, if an organic pigment such as a gardenia blue pigment is used, the decomposition energy of the photocatalyst is used to decompose the pigment. This results in a decrease in the VOC removal ability of the photocatalyst coating layer and fading or discoloration of the photocatalyst coating layer due to photocatalytic activity.

The present disclosure has been made in view of the above circumstances and provides a photocatalyst coating liquid that can prevent deterioration of the aesthetic appearance of a blue-based color base material and that can prevent deterioration of the VOC removal ability of a photocatalyst coating layer and fading or discoloration of the photocatalyst coating layer due to photocatalytic activity.

### SUMMARY OF THE INVENTION

The present disclosure provides a photocatalyst coating liquid that includes a visible light-responsive photocatalyst particle containing tungsten oxide, a water-soluble copper compound, and an aqueous medium. The photocatalyst coating liquid has a hue of green, blue-green, or blue, and the hue belongs to a region of 5G to 10B on the hue wheel of the Munsell color system.

The photocatalyst coating liquid of the present disclosure includes the photocatalyst particle and the water-soluble copper compound. The color of the photocatalyst particle is pale yellow to green-yellow, and the water-soluble copper compound exhibits a blue color in the aqueous medium. As a result, the color of the photocatalyst coating liquid is a mixture of the color of the photocatalyst particle and the color of the water-soluble copper compound, and this color mixture has a hue (of green, blue-green, or blue) belonging to a region of 5G to 10B on the hue wheel of the Munsell color system. That is, the photocatalyst coating liquid includes the photocatalyst particle and the water-soluble copper compound so as to exhibit the hue that belongs to the region of 5G to 10B on the hue wheel of the Munsell color system. Because the photocatalyst coating liquid has such a hue, when the photocatalyst coating liquid is applied onto a blue-based color base material to form a photocatalyst coating layer, the photocatalyst coating layer exhibiting a blue-based color can prevent deterioration of the aesthetic appearance of the base material. Further, using the water-soluble copper compound as a blue pigment can prevent fading or discoloration of the photocatalyst coating layer due to photocatalytic activity, thereby preventing a decrease in the photocatalytic activity of the photocatalyst coating layer. Further, the water-soluble copper compound having antibacterial and antiviral properties can provide the photocatalyst coating layer with the antibacterial and antiviral properties.

### BRIEF DESCRIPTION OF THE DRAWINGS

The FIG. is an explanatory diagram of a method for forming a photocatalyst coating layer using a photocatalyst coating liquid of the present disclosure.

### DESCRIPTION OF THE PREFERRED EMBODIMENTS

A photocatalyst coating liquid of the present disclosure includes a visible light-responsive photocatalyst particle containing tungsten oxide, a water-soluble copper compound, and an aqueous medium. The photocatalyst coating liquid has a hue of green, blue-green, or blue, and the hue belongs to a region of 5G to 10B on the hue wheel of the Munsell color system.

It is preferable that a ratio of the copper contained in the water-soluble copper compound relative to the photocatalyst coating liquid is 20 ppm or more, and a weight ratio (B/A) of the water-soluble copper compound (B) relative to the photocatalyst particle (A) in the photocatalyst coating liquid is (12.5/100) or less.

The turbidity of the photocatalyst coating liquid measured by a transmitted light measurement method is preferably 0.1 or more and 2.5 or less.

The water-soluble copper compound preferably includes copper gluconate.

The photocatalyst coating liquid preferably includes a dispersant. Further, the dispersant is preferably a nonionic dispersant, more preferably a polyoxyalkylene group-containing compound or an aliphatic polyether derivative. The polyoxyalkylene compound may be a polymer amine compound. The dispersant is preferably a polymer compound with an average molecular weight of 10,000 or less.

It is preferable that a weight ratio (D/C) of the dispersant (D) relative to the copper atoms (C) contained in the water-soluble copper compound in the photocatalyst coating liquid is (5000/100) or more, and a weight ratio (D/A) of the dispersant (D) relative to the photocatalyst particle (A) in the photocatalyst coating liquid is (1000/100) or less.

A ratio of the photocatalyst particle relative to the photocatalyst coating liquid is preferably 0.1 wt % or more and 1.5 wt % or less.

Hereinafter, one embodiment of the present disclosure will be described using the drawing. The accompanying drawing and the description below merely illustrate exemplary configurations, to which the scope of the present disclosure is in no way limited.

The FIG. is an explanatory diagram of a method for forming the photocatalyst coating layer using the photocatalyst coating liquid of the present embodiment.

A photocatalyst coating liquid 2 of the present embodiment includes a visible light-responsive photocatalyst particle containing tungsten oxide, a water-soluble copper compound, and an aqueous medium. The photocatalyst coating liquid 2 has a hue of green, blue-green, or blue, and the hue belongs to a region of 5G to 10B on the hue wheel of the Munsell color system. The photocatalyst coating liquid 2 may include a dispersant.

The photocatalyst coating liquid 2 is a dispersion liquid in which the photocatalyst particles are dispersed in the aqueous medium. Further, the water-soluble copper compound is dissolved in the aqueous medium. Further, the photocatalyst coating liquid 2 is a dispersion liquid that is applied to the surface of a base material 4 by a coating method.

In a method for producing the photocatalyst coating liquid 2, first, the photocatalyst particles are finely dispersed in water, and then the water-soluble copper compound is dissolved in and mixed with the resulting dispersant. If necessary, the photocatalyst particles may be diluted with a solvent in advance, or a dispersant may be added. The photocatalyst particles can generally be dispersed in water using a wet dispersion device (such as an ultrasonic dispersion device, a colloid mill, or a bead mill). A general liquid mixer can be used for mixing, and if it is equipped with a stirring blade or the like, the composition of the photocatalyst coating liquid 2 can be made more uniform.

A coating method for the photocatalyst coating liquid 2 is not particularly limited. However, examples thereof include spray coating, a bar coating method, brush coating, dip coating, a screen printing method, a spin coating method, and roll coating. For example, as shown in the FIGURE, the photocatalyst coating liquid 2 is applied by spraying onto the surface of the base material 4 to form a coating film 5. The coating film 5 thus formed is dried to form a photocatalyst coating layer 6. Further, a photocatalyst coating member 10 having the photocatalyst coating layer 6 can also be formed. The photocatalyst coating layer 6 formed by applying and drying the photocatalyst coating liquid 2 exhibits photocatalytic effects such as deodorization upon light irradiation.

For applying the photocatalyst coating liquid 2, it is preferable to use an electric spray gun (e.g., a hand spray 3), and it is more preferable to use a high volume, low pressure (HVLP) gun or the like. This allows the photocatalyst coating liquid 2 to be applied finely, thinly, uniformly, and evenly to the base material 4.

Examples of the base material 4 include a wallpaper, a curtain, a building interior wall, a building exterior wall, a room ceiling, a building floor, furniture, a window, glass, a plastic, metal, a ceramic, wood, a stone, cement, concrete, a fiber, a filter, a fabric, a paper, and leather. The color of the base material 4 may be a blue-based color. Examples of the blue-based color include blue, sky blue, light blue, lapis lazuli, ultramarine, indigo, navy blue, cyan, and peacock blue. Further, the color of the base material 4 may have hues belonging to green-yellow (GY), green (G), blue-green (BG), blue (B), and purple-blue (PB) out of the 10 basic colors of the Munsell color system (red, yellow-red, yellow, green-yellow, green, blue-green, blue, purple-blue, purple, and red-purple).

In order to sufficiently exhibit the photocatalytic performance, the base material 4 desirably does not include a migratory component such as a plasticizer.

The aqueous medium includes water as a main component. Further, the aqueous medium may be a mixture of water and an alcohol (e.g., ethanol). Further, a ratio of water relative to the aqueous medium is, for example, 30 wt % or more and 100 wt % or less. The aqueous medium preferably includes ethanol. This can improve dispersibility of the photocatalyst particles in the photocatalyst coating liquid 2. The ratio of ethanol relative to the aqueous medium is, for example, 1 wt % or more and 70 wt % or less.

The visible light-responsive photocatalyst particles are particles that exhibit photocatalytic activity upon receiving visible light, and they include a tungsten oxide particle (WO₃ particle). The photocatalyst particles can exhibit effects such as organic matter decomposition upon light irradiation. The color of tungsten oxide is pale yellow to green-yellow. The photocatalyst coating layer 6 including the photocatalyst particles can have a deodorizing function, an antibacterial function, an antiviral function, and the like.

The photocatalyst particles are mainly composed of tungsten oxide (WO₃). The tungsten oxide particle having a composition deviating from the stoichiometric composition may be used as long as it has photocatalytic activity. Further, the tungsten oxide particle may include an impurity atom or an additive atom in a range of not deteriorating the photocatalytic activity.

The photocatalyst coating liquid 2 can include the photocatalyst particles in an amount of 0.1 wt % or more and 1.5 wt % or less relative to the photocatalyst coating liquid 2.

The photocatalyst particles may be obtained by adding, to the WO₃ particles, a co-catalyst that reduces the energy gap of the WO₃ particles, thereby increasing the responsiveness in the visible light region. As the co-catalyst, platinum group metal such as Pt, Pd, Rh, Ru, Os, or Ir is preferable. The 50% volume cumulative diameter of the photocatalyst particles is preferably 1 nm or more and 500 nm or less. Further, when the 50% volume cumulative diameter is 5 nm or more, there is little aggregation in the photocatalyst coating liquid 2, making redispersion easy. Further, when the 50% volume cumulative diameter of the photocatalyst particles is 200 nm or less, the photocatalyst particles are easily mixed uniformly with other components in the process of preparing the photocatalyst coating liquid 2 with little separation, which is preferable. The particle diameter can be measured using a BET specific surface area meter, a laser diffraction particle size distribution meter, a dynamic light scattering particle size distribution meter, or the like.

The dispersant is a component for dispersing the photocatalyst particles in the aqueous medium. The photocatalyst coating liquid 2 including the dispersant can improve the dispersibility of the photocatalyst particles in the aqueous medium. Normally, when metal ions are added to the photocatalyst particle dispersion liquid, the ions neutralize the surface charge of the photocatalyst particles, thereby weakening electrostatic repulsion and causing a reduction in the dispersibility. The dispersant can prevent the above ion effects by increasing electrostatic repulsion and by virtue of steric hindrance caused by polymer chains, thereby improving the dispersibility of the photocatalyst particles. Further, the dispersant included in the photocatalyst coating liquid 2 facilitates development of the blue color in the photocatalyst coating liquid 2.

Examples of the dispersant that can be used in the present embodiment include an anionic surfactant (anionic dispersant), a nonionic surfactant (nonionic dispersant), a cationic surfactant (cationic dispersant), an amphoteric surfactant (amphoteric dispersant), an aliphatic polyether derivative, and polyethylene glycol.

Examples of the anionic surfactant include an alkyl sulfate, a polyoxyethylene alkyl ether sulfate, an alkylbenzene sulfonate, an alkylnaphthalene sulfonate, an alkyl sulfosuccinate, an alkyl diphenyl ether disulfonate, a naphthalene sulfonic acid formalin condensate, a polyoxyethylene polycyclic phenyl ether sulfate, a polyoxyethylene distyrenated phenyl ether sulfate, a fatty acid salt, an alkyl phosphate, and a polyoxyethylene alkyl phenyl ether sulfate. Examples of the nonionic surfactant include a polyoxyethylene alkyl ether, a polyoxyalkylene alkyl ether, a polyoxyethylene polycyclic phenyl ether, a polyoxyethylene distyrenated phenyl ether, a sorbitan fatty acid ester, a polyoxyethylene sorbitan fatty acid ester, a polyoxyethylene sorbitol fatty acid ester, a glycerin fatty acid ester, a polyoxyethylene fatty acid ester, a polyoxyethylene alkyl amine, an alkyl alkanolamide, and a polyoxyethylene alkyl phenyl ether.

Examples of the cationic surfactant include a quaternary ammonium salt such as alkyltrimethylammonium bromide, alkylpyridinium bromide, or imidazolinium laurate, a pyridinium salt, and an imidazolinium salt.

Examples of the amphoteric surfactant include lauryl betaine and lauryl dimethylamine oxide. Of these, the nonionic surfactant (nonionic dispersant) is preferable, and the surfactant having a polyoxyalkylene group, which may be an amine compound, is more preferable.

The photocatalyst coating liquid 2 including the dispersant can prevent the droplets and the photocatalyst particles dried in the air from becoming excessively charged when the photocatalyst coating liquid 2 is sprayed. This makes it possible to prevent the photocatalyst particles from excessively concentrating and adhering to objects that are electrostatically charged in the spraying range and causing the adhered surface to become white.

The average molecular weight of the dispersant is preferably 100 or more and less than 10,000, more preferably 200 or more and less than 2,000. If the molecular weight of the dispersant is too small, its volatility becomes high, and the sprayed droplets are dried in the air and become solid before contacting the wall, causing a reduction in the anti-whitening effect. Further, if the molecular weight of the dispersant is too large, the photocatalyst particles mainly decompose nearby organic matters after application and are occupied in decomposing the surrounding dispersant. As a result, it takes time for the photocatalyst particles to become effective in decomposing organic gases in the air shortly after application. Examples of the dispersant with small molecular weight that has little effect on the photocatalytic effect include ESLEAM (polyoxyalkylene group-containing compound) manufactured by NOF Corp. and PEG200 (polyethylene glycol) manufactured by TOHO Chemical Industry Co., Ltd.

The water-soluble copper compound is a copper compound that dissolves in water. Since the photocatalyst coating liquid 2 includes the water-soluble copper compound, the photocatalyst coating liquid 2 and the photocatalyst coating layer 6 can be made blue. In the photocatalyst coating liquid 2, copper ions form a complex with water molecules and counter ions, and the resulting complex absorbs light and thus exhibits a blue color. As the water-soluble copper compound, copper sulfate, copper nitrate, copper chloride, copper acetate, copper gluconate, or the like, or a hydrate thereof can be used.

The water-soluble copper compound is dissolved in the aqueous medium in the photocatalyst coating liquid 2. This can prevent sedimentation of the copper compound. Further, since the copper ions have antibacterial properties, the photocatalyst coating liquid 2 and the photocatalyst coating layer 6 can have antibacterial properties. Further, since the copper ions are not organic substances, the color of the photocatalyst coating liquid 2 and the color of the photocatalyst coating layer 6 can be prevented from changing due to photocatalytic activity.

When the water-soluble copper compound is dissolved in a solvent containing water, the copper ions form a complex with counterions and water molecules, and the resulting complex absorbs light and exhibits a blue color. The color is developed when the copper ions absorb light. Thus, if the concentration of opaque particles such as the photocatalyst particles is high in the liquid, the light is blocked by the opaque particles, making it difficult for the copper ions to absorb enough light to develop the color. Thus, the concentration of the opaque particles in the liquid needs to be sufficiently low.

Since the copper (II) ion aqueous solution has a blue-based color, the color of the photocatalyst coating liquid 2 including the water-soluble copper compound and the photocatalyst particles has a mixed color of the color of the copper ions and the color of the photocatalyst particles. As a result, the photocatalyst coating liquid 2 can have a hue (of green, blue-green, or blue) belonging to a region of 5G to 10B on the hue wheel of the Munsell color system. The photocatalyst coating liquid 2 more preferably has a hue (of green or blue-green) belonging to a region of 5G to 5 GB on the hue wheel of the Munsell color system.

The Munsell color system is one of methods of representing colors, and colors are represented as Munsell values using hue (H), brightness (V), and chroma (C).

The hue (H) represents colors with 40 different hues using 10 basic colors, red (R), yellow-red (YR), yellow (Y), green-yellow (GY), green (G), blue-green (BG), blue (B), purple-blue (PB), purple (P), and red-purple (RP), and their brightness (2.5, 5, 7.5, and 10) (e.g., 10G, 2.5B, etc.). The hue wheel is a ring-shaped arrangement of the 40 different hues.

The brightness (V) represents the color brightness with a numerical value from 0 to 10. The darker the color, the lower the numerical value, and the brighter the color, the higher the numerical value.

The chroma (C) represents a numerical expression of purity. The less pure the color, the lower the numerical value, and the purer the color, the higher the numerical value.

The Munsell value is a numerical expression (HV/C) that combines these three properties (hue, brightness, and chroma) (e.g., 5G8.5/1).

The hue, brightness, and chroma can be determined by comparing the color of an object with the color chart in the Munsell color system. Further, the hue, brightness, and chroma can also be determined by measuring the color with a colorimeter.

It is preferable that the ratio of the copper contained in the water-soluble copper compound relative to the photocatalyst coating liquid 2 is 20 ppm or more, and the weight ratio (B) of the water-soluble copper compound (B) relative to the photocatalyst particles (A) in the photocatalyst coating liquid 2 is (12.5/100) or less. As a result, the photocatalyst coating liquid 2 can have a hue belonging to the region of 5G to 10B, and the photocatalyst coating layer 6 formed using the photocatalyst coating liquid 2 can have excellent photocatalytic performance.

The turbidity of the photocatalyst coating liquid 2 measured by a transmitted light measurement method is preferably 0.1 or more and 2.5 or less, more preferably 0.1 or more and 1.2 or less. As a result, the photocatalyst coating liquid 2 can have a hue belonging to the region of 5G to 10B, and the photocatalyst coating layer 6 formed using the photocatalyst coating liquid 2 can have excellent photocatalytic performance.

It is preferable that the weight ratio (D/C) of the dispersant (D) relative to the copper atoms (C) contained in the water-soluble copper compound in the photocatalyst coating liquid 2 is (5000/100) or more, and the weight ratio (D/A) of the dispersant (D) relative to the photocatalyst particles (A) in the photocatalyst coating liquid 2 is (1000/100) or less. The weight ratio (D/A) is more preferably (50/100) or more and (300/100) or less. As a result, the photocatalyst coating layer 6 formed using the photocatalyst coating liquid 2 can have excellent photocatalytic performance, and aggregation and sedimentation of the photocatalyst particles in the photocatalyst coating liquid 2 can be prevented.

### Preparation of Photocatalyst Coating Liquids

A photocatalyst tungsten oxide powder (photocatalyst particles), the dispersant, the copper compound, ethanol, and pure water were mixed according to the composition shown in Table 1, and the resulting mixtures were stirred and dispersed to prepare the photocatalyst coating liquids of Examples 1 to 11 and Comparative examples 1 to 6.

As the dispersant, a nonionic dispersant, “ESLEAM (polyoxyalkylene group-containing compound)” manufactured by NOF Corp. or polyethylene glycol was used.

As the copper compound, copper gluconate (molecular weight: 453.84), which was a water-soluble copper compound, was used. The atomic weight of copper is 63.55, and the ratio of the copper relative to copper gluconate is about 14 wt %.

### Evaluation of Color of Photocatalyst Coating Liquids

The color of the prepared photocatalyst coating liquids of Examples 1 to 11 and Comparative examples 1 to 6 was represented as Munsell values using the Munsell color system. Specifically, under white LED illumination (color temperature: 5000 K, illuminance: 500 1×), the color of the photocatalyst coating liquid in a vial was compared with the color chart (Standard Paint Colors 2017 J-edition Pocket type according to Japan Paint Manufacturers Association), and the Munsell hue of the closest color on the color chart (Munsell color wheel) was taken as the hue (H) of the photocatalyst coating liquid. Further, the color of the photocatalyst coating liquid was compared with the Munsell color chart to determine the brightness(V) and chroma (C) of the color of the photocatalyst coating liquid. Table 1 shows the Munsell values (HV/C) of the color of the photocatalyst coating liquids. Table 1 also shows color evaluation. In Table 1, if the hue of the photocatalyst coating liquid was the same as the hue (of blue to blue-green) belonging to the region of 5G to 10B on the hue wheel of the Munsell color system, the color of the photocatalyst coating liquid was evaluated as “good”. If the hue of the photocatalyst coating liquid was different from the hue belonging to the above region, the color of the photocatalyst coating liquid was evaluated as “poor”. Further, Table 2 to Table 5 also show color evaluation.

TABLE 1

| Photocatalyst | Composition | | | | | | | Munsell | |
|---|---|---|---|---|---|---|---|---|---|
| coating | Photocatalyst | | | Copper | | | | values | Color |
| liquids | particles | Dispersant | | compound | Ethanol | | Pure water | (HV/C) | evaluation |
| Example 1 | 0.4 wt % | ESLEAM | 0.3 wt % | 0.03 wt % | 50 | wt % | 49.3 wt % | 5G8.5/1 | Good |
| Example 2 | 0.4 wt % | ESLEAM | 0.3 wt % | 0.10 wt % | 50 | wt % | 49.2 wt % | 5BG8.5/1 | Good |
| Example 3 | 0,8 wt % | ESLEAM | 0.8 wt % | 0.10 wt % | 50 | wt % | 48.3 wt % | 5BG8/2 | Good |
| Example 4 | 0.8 wt % | ESLEAM | 0.8 wt % | 0.10 wt % | 0 | wt % | 98.3 wt % | 5BG8/2 | Good |
| Example 5 | 0.4 wt % | ESLEAM | 0.3 wt % | 0.02 wt % | 50 | wt % | 49.3 wt % | 5G8.5/1 | Good |
| Example 6 | 0.4 wt % | ESLEAM | 0.3 wt % | 0.04 wt % | 50 | wt % | 49.3 wt % | 5G8.5/1 | Good |
| Example 7 | 0.4 wt % | ESLEAM | 0.3 wt % | 0.05 wt % | 50 | wt % | 49.3 wt % | 5G8.5/1 | Good |
| Example 8 | 0.01 wt % | ESLEAM | 0.05 wt % | 0.10 wt % | 50 | wt % | 49.8 wt % | 10B8/4 | Good |
| Example 9 | 0.8 wt % | ESLEAM | 0.6 wt % | 0.10 wt % | 50 | wt % | 48.5 wt % | 5BG8.5/1 | Good |
| Example 10 | 0.8 wt % | ESLEAM | 10.5 wt % | 0.10 wt % | 50 | wt % | 38.6 wt % | 5B7/4 | Good |
| Example 11 | 0.4 wt % | PEG | 0.3 wt % | 0.03 wt % | 50 | wt % | 49.3 wt % | 5G8.5/1 | Good |
| Comparative | 0.4 wt % | ESLEAM | 0.3 wt % | 0.01 wt % | 50 | wt % | 49.3 wt % | 10GY8/1 | Poor |
| example 1 | | | | | | | | | |
| Comparative | 0.4 wt % | ESLEAM | 0.3 wt % | 0.00 wt % | 50 | wt % | 49.3 wt % | 5GY9.2/1 | Poor |
| example 2 | | | | | | | | | |
| Comparative | 0.8 wt % | ESLEAM | 0.8 wt % | 0.00 wt % | 50 | wt % | 48.4 wt % | 10Y9.2/1 | Poor |
| example 3 | | | | | | | | | |
| Comparative | 0.4 wt % | ESLEAM | 0.0 wt % | 0.03 wt % | 0 | wt % | 99.6 wt % | 5GY9/1 | Poor |
| example 4 | | | | | | | | | |
| Comparative | 0.8 wt % | ESLEAM | 0.0 wt % | 0.10 wt % | 0 | wt % | 99.1 wt % | 7.5GY8/2 | Poor |
| example 5 | | | | | | | | | |
| Comparative | 5.0 wt % | ESLEAM | 5.0 wt % | 0.10 wt % | 50 | wt % | 39.9 wt % | 5GY9.2/1 | Poor |

example 6

The photocatalyst coating liquids of Comparative examples 2 and 3, which did not include the copper compound, were evaluated as “poor” in the color evaluation. Thus, it is thought that, in order to make the color of the photocatalyst coating liquid blue to blue-green, the photocatalyst coating liquid needs to include the copper compound.

The photocatalyst coating liquids of Comparative examples 4 and 5, which included the copper compound but did not include the dispersant, were evaluated as “poor” in the color evaluation. Thus, it is thought that when the photocatalyst coating liquid includes both the copper compound and the dispersant, the photocatalyst coating liquid can be easily made blue to blue-green.

### Evaluation of Dispersibility of Photocatalyst Coating Liquids

The dispersibility of the photocatalyst coating liquids was evaluated by allowing the prepared photocatalyst coating liquids to stand and observing the state of aggregation and sedimentation. Table 2 shows evaluation of the dispersibility of the photocatalyst coating liquids of Examples 3 and 4, the composition of the photocatalyst coating liquids, and the color (Munsell values) of the photocatalyst coating liquids. Table 5 also shows the evaluation of the dispersibility.

In the evaluation of the dispersibility, the photocatalyst coating liquid in which no aggregation or sedimentation was observed when the photocatalyst coating liquid was allowed to stand for 24 hours at room temperature was evaluated as “good”, and the photocatalyst coating liquid in which aggregation or sedimentation was observed within several hours at room temperature was evaluated as “fair”. Further, the photocatalyst coating liquid in which aggregation or sedimentation was observed immediately after standing was evaluated as “poor”.

TABLE 2

| Photocatalyst | Composition | | | | | Munsell | | |
|---|---|---|---|---|---|---|---|---|
| coating | Photocatalyst | | Copper | | Pure | values | Evaluation | |
| liquids | particles | Dispersant | compound | Ethanol | water | (HV/C) | Color | Dispersibility |
| Example 3 | 0.8 wt % | 0.8 wt % | 0.10 wt % | 50 wt % | 48.3 wt % | 5BG8/2 | Good | Good |
| Example 4 | 0.8 wt % | 0.8 wt % | 0.10 wt % | 0 wt % | 98.3 wt % | 5BG8/2 | Good | Fair |

The dispersion medium included in the photocatalyst coating liquid of Example 4 whose dispersibility evaluation is “fair” is water, while the dispersion medium included in the photocatalyst coating liquid of Example 3 whose dispersibility evaluation is “good” is a mixture of water and ethanol. Thus, it is thought that the dispersibility of the photocatalyst coating liquid improves when the dispersion medium includes ethanol.

### Evaluation of Photocatalytic Performance

The prepared photocatalyst coating liquid in a wet weight of 1.6 g was evenly dropped onto a cellulose nonwoven fabric (12.5 cm square) using a dropper to form a coating film on the surface of the nonwoven fabric, and this coating film was dried to form a photocatalyst coating layer. The nonwoven fabric with the photocatalyst coating layer was pre-irradiated with blue LED light (4500 1×) for 48 hours to prepare a sample for measuring organic gas decomposition performance. The sample thus produced was placed in a 1 L gas bag, and then 50 ppm of acetaldehyde gas was injected into the gas bag. After the sample inside the gas bag was irradiated with blue LED light (4500 1×) for 1 hour, the acetaldehyde concentration inside the gas bag was measured using a detection tube. Then, an acetaldehyde residual ratio was calculated using the following formula.

$$Acetaldehyde residual ratio ( \% ) = ( acetaldehyde concentration after blue light irradiation ) \text{} / ( initial acetaldehyde concentration ( 50 ppm ) ) \times 100$$

Table 3 shows evaluation of the photocatalytic performance of the photocatalyst coating liquids (photocatalyst coating layers) of Examples 1, 2, 5, 6, and 7 and the photocatalyst coating liquid (photocatalyst coating layer) of Comparative example 1, the concentration of the copper atoms (copper atoms included in the copper compound) in the photocatalyst coating liquids, the weight ratio of the copper compound relative to the photocatalyst particles (copper compound/photocatalyst) in the photocatalyst coating liquids, the composition of the photocatalyst coating liquids, and evaluation of the color of the photocatalyst coating liquids. Evaluation of the photocatalytic performance is also shown in Table 4 and Table 5.

In the evaluation of the photocatalytic performance, the photocatalyst coating liquid (photocatalyst coating layer) with the acetaldehyde residual ratio of 10% or less was evaluated as “excellent”, the photocatalyst coating liquid (photocatalyst coating layer) with the acetaldehyde residual ratio of 10 to 20% was evaluated as “good”, and the photocatalyst coating liquid (photocatalyst coating layer) with the acetaldehyde residual ratio of 20 to 90% was evaluated as “fair”. The photocatalyst coating liquid (photocatalyst coating layer) with the acetaldehyde residual ratio of 90 to 100% was evaluated as “poor”. However, there was no photocatalyst coating liquid evaluated as “poor”.

TABLE 3

| Photocatalyst | Composition | | | | | | Copper compound/ | | |
|---|---|---|---|---|---|---|---|---|---|
| coating | Photocatalyst | | Copper | | Pure | Cu | photocatalyst | Evaluation | Photocatalytic |
| liquids | particles | Dispersant | compound | Ethanol | water | [ppm] | weight ratio | Color | performance |
| Comparative | 0.4 wt % | 0.3 wt % | 0.01 wt % | 50 wt % | 49.3 wt % | 14 | 3/100 | Poor | Excellent |
| example 1 | | | | | | | | | |
| Example 5 | 0.4 wt % | 0.3 wt % | 0.02 wt % | 50 wt % | 49.3 wt % | 28 | 5/100 | Good | Excellent |
| Example 1 | 0.4 wt % | 0.3 wt % | 0.03 wt % | 50 wt % | 49.3 wt % | 42 | 8/100 | Good | Excellent |
| Example 6 | 0.4 wt % | 0.3 wt % | 0.04 wt % | 50 wt % | 49.3 wt % | 56 | 10/100 | Good | Good |
| Example 7 | 0.4 wt % | 0.3 wt % | 0.05 wt % | 50 wt % | 49.3 wt % | 70 | 13/100 | Good | Fair |
| Example 2 | 0.4 wt % | 0.3 wt % | 0.10 wt % | 50 wt % | 49.2 wt % | 140 | 25/100 | Good | Fair |

The color of the photocatalyst coating liquids of Examples 1, 2, 5, 6, and 7, in which the concentration of the copper atoms in the photocatalyst coating liquids was 20 ppm or more, was evaluated as “good”. Thus, it is thought that the color of the photocatalyst coating liquid can be made blue to blue-green by adjusting the copper atom concentration to 20 ppm or more.

Further, when the weight ratio of the copper compound relative to the photocatalyst particles (copper compound/photocatalyst) in the photocatalyst coating liquid was 12.5/100 or less, the photocatalytic performance was evaluated as “excellent” or “good”. Thus, the photocatalytic activity of the photocatalyst coating layer can be increased by adjusting the weight ratio of the copper compound relative to the photocatalyst particles in the photocatalyst coating liquid to 12.5/100 or less.

### Evaluation of Turbidity of Photocatalyst Coating Liquids

The photocatalyst coating liquids were placed into PCR tubes (0.2 mL) for measuring absorbance, and the PCR tubes were set in a photo absorbance meter (PAS-110-YU manufactured by Ushio Inc.) to measure the turbidity (optical density, O.D.) of the photocatalyst coating liquids (transmitted light measurement method using color sensor, peak wavelength: 615 nm, wavelength range: 575 nm to 660 nm).

Table 4 shows the turbidity of the photocatalyst coating liquids of Examples 1, 3, and 8 and the photocatalyst coating liquid of Comparative example 6, the composition of the photocatalyst coating liquids, evaluation of the color of the photocatalyst coating liquids, and evaluation of the photocatalytic performance of the photocatalyst coating liquids (photocatalyst coating layers).

TABLE 4

| Photocatalyst | Composition | | | | | | | |
|---|---|---|---|---|---|---|---|---|
| coating | Photocatalyst | | Copper | | Pure | Turbidity | Evaluation | Photocatalytic |
| liquids | particles | Dispersant | compound | Ethanol | water | (O.D.) | Color | performance |
| Example 8 | 0.01 wt % | 0.05 wt % | 0.10 wt % | 50 wt % | 49.8 wt % | 0.09 | Good | Fair |
| Example 1 | 0.4 wt % | 0.3 wt % | 0.03 wt % | 50 wt % | 49.3 wt % | 0.61 | Good | Excellent |
| Example 3 | 0.8 wt % | 0.8 wt % | 0.10 wt % | 50 wt % | 48.3 wt % | 0.92 | Good | Excellent |
| Comparative | 5.0 wt % | 5.0 wt % | 0.10 wt % | 50 wt % | 39.9 wt % | 2.56 | Poor | |
| example 6 | | | | | | | | |

As the concentration of the photocatalyst particles in the photocatalyst coating liquid increases, the turbidity of the photocatalyst coating liquid increases. Further, when the turbidity was 2.5 or higher, the color of the photocatalyst coating liquid was evaluated as “poor”. Thus, it is thought that the color of the photocatalyst coating liquid can be made blue to blue-green by adjusting the concentration of the photocatalyst particles so that the turbidity is lower than 2.5. Further, with the concentration of the photocatalyst particles where the turbidity was 0.1 or lower, the photocatalytic performance was evaluated as “fair”.

### Component Ratio of Photocatalyst Coating Liquids

Table 5 shows the component composition of the photocatalyst coating liquids of Examples 1, 3, 7, 9, and 10, the weight ratio of the dispersant relative to the copper atoms (copper atoms included in the copper compound) in the photocatalyst coating liquids, the weight ratio of the dispersant relative to the photocatalyst particles in the photocatalyst coating liquids, evaluation of the color of the photocatalyst coating liquids, evaluation of the dispersibility of the photocatalyst coating liquids, and evaluation of the photocatalyst performance.

TABLE 5

| Photocatalyst | Composition | | | | | Dispersant/ | Dispersant | | | |
|---|---|---|---|---|---|---|---|---|---|---|
| coating | Photocatalyst | | Copper | | Pure | Cu weight | photocatalyst | Evaluation | | Photocatalytic |
| liquids | particles | Dispersant | compound | Ethanol | water | ratio | weight ratio | Color | Dispersibility | performance |
| Example 1 | 0.4 wt % | 0.3 wt % | 0.03 wt % | 50 wt % | 49.3 wt % | 71/1 | 0.8/1 | Good | Good | Excellent |
| Example 7 | 0.4 wt % | 0.3 wt % | 0.05 wt % | 50 wt % | 49.3 wt % | 43/1 | 0.8/1 | Good | Fair | Fair |
| Example 9 | 0.8 wt % | 0.6 wt % | 0.10 wt % | 50 wt % | 48.5 wt % | 48/1 | 0.8/1 | Good | Fair | Excellent |
| Example 3 | 0.8 wt % | 0.8 wt % | 0.10 wt % | 50 wt % | 48.3 wt % | 63/1 | 1.0/1 | Good | Good | Excellent |
| Example 10 | 0.8 wt % | 10.5 wt % | 0.10 wt % | 50 wt % | 38.6 wt % | 750/1 | 13/1 | Good | Good | Fai |

As is evident from Table 5, the dispersibility of the photocatalyst coating liquid can improve by including the dispersant and the copper compound in the photocatalyst coating liquid such that the weight ratio of the dispersant relative to the copper atoms (dispersant/copper atoms) in the photocatalyst coating liquid is greater than 50/1. Further, the photocatalytic performance of the photocatalyst coating liquid (photocatalyst coating layer) can improve by adjusting the weight ratio of the dispersant relative to the photocatalyst particles (dispersant/photocatalyst particles) in the photocatalyst coating liquid to be lower than 10/1. It is thought that, in the photocatalyst coating liquid of Example 7, evaluation of the photocatalytic performance was low (see Table 3) as the weight ratio of the copper compound relative to the photocatalyst particles exceeded 12.5/100.

### Evaluation of Color of Photocatalyst Coating Layers

A photocatalyst tungsten oxide powder (photocatalyst particles), ethanol, and pure water were mixed with the composition shown in Table 6, and the resulting mixture was stirred and dispersed to prepare the photocatalyst coating liquid of Comparative examples 7.

The photocatalyst coating liquids of Example 1, Example 3, and Comparative example 7 were each sprayed onto a cellulose nonwoven fabric (12.5 cm square) (base material) using a trigger type spray nozzle to form a coating film on the surface of the nonwoven fabric. This coating film was dried to form a photocatalyst coating layer.

The spraying amount of the photocatalyst coating liquid was adjusted such that the application amount of the photocatalyst particles was 3 g/m².

Table 6 showed the Munsell values of the color (mixed color of the color of the base material and the color of the photocatalyst coating layer) of the formed photocatalyst coating layers of Examples 1, 3, and Comparative example 7, and the Munsell value of the color of the base material (nonwoven fabric) on which no photocatalyst coating layer was formed. Specifically, under white LED illumination (color temperature: 5000 K, illuminance: 500 1×), the color of the photocatalyst coating layers and the color of the nonwoven fabric were each compared with the color chart (Standard Paint Colors 2017 J-edition Pocket type according to Japan Paint Manufacturers Association), and the Munsell hue of the closest color on the color chart (Munsell color wheel) was taken as the hue (H) of the photocatalyst coating layer or the hue (H) of the nonwoven fabric. Further, the color of the photocatalyst coating layers and the color of the nonwoven fabric were each compared with the Munsell color chart to determine the brightness(V) and chroma (C) of the color of the photocatalyst coating layers and the color of the nonwoven fabric.

TABLE 6

| | | | | | | | Application | |
|---|---|---|---|---|---|---|---|---|
| Photocatalyst | Composition | | | | | | amount | Munsell |
| coating | Photocatalyst | | Copper | | Pure | Base | (photocatalyst) | values |
| liquids | particles | Dispersant | compound | Ethanol | water | material | [g/m²] | (HV/C) |
| None | — | — | — | — | — | Nonwoven | 0 | 2.5Y9/0.5 |
| | | | | | | fabric | | |
| Comparative | 0.4 wt % | 0.0 wt % | 0.00 wt % | 0 wt % | 99.6 wt % | Nonwoven | 3 | 7.5Y9/1 |
| example 7 | | | | | | fabric | | |
| Example 1 | 0.4 wt % | 0.3 wt % | 0.03 wt % | 50 wt % | 49.3 wt % | Nonwoven | 3 | 5GY9/0.5 |
| | | | | | | fabric | | |
| Example 3 | 0.8 wt % | 0.8 wt % | 0.10 wt % | 50 wt % | 48.3 wt % | Nonwoven | 3 | 5GY9.2/1 |
| | | | | | | fabric | | |

The color (mixed color of the color of the base material and the color of the photocatalyst coating layer) of the photocatalyst coating layers of Examples 1 and 3 was cooler than the color (mixed color of the color of the base material and the color of the photocatalyst coating layer) of the photocatalyst coating layer of Comparative example 7 and the color of the base material (non-woven fabric). Thus, it is thought that even if the photocatalyst coating liquid of Example 1 or 3 is applied to the blue-based color base material to form the photocatalyst coating layer, deterioration of the aesthetic appearance of the blue-based color base material can be prevented.

What is claimed is:

1. A photocatalyst coating liquid comprising:
a visible light-responsive photocatalyst particle containing tungsten oxide;
a water-soluble copper compound; and
an aqueous medium, wherein:
the photocatalyst coating liquid has a hue of green, blue-green, or blue; and
the hue belongs to a region of 5G to 10B on a hue wheel of a Munsell color system.

2. The photocatalyst coating liquid according to claim 1, wherein:
a ratio of copper included in the water-soluble copper compound relative to the photocatalyst coating liquid is 20 ppm or more; and
a weight ratio (B/A) of the water-soluble copper compound (B) relative to the photocatalyst particle (A) in the photocatalyst coating liquid is (12.5/100) or less.

3. The photocatalyst coating liquid according to claim 1, wherein a turbidity of the photocatalyst coating liquid measured by a transmitted light measurement method is 0.1 or more and 2.5 or less.

4. The photocatalyst coating liquid according to claim 1, further comprising a dispersant, wherein the dispersant is a nonionic dispersant.

5. The photocatalyst coating liquid according to claim 4, wherein:
a weight ratio (D/C) of the dispersant (D) relative to copper atom (C) included in the water-soluble copper compound in the photocatalyst coating liquid is (5000/100) or more; and
a weight ratio (D/A) of the dispersant (D) relative to the photocatalyst particle (A) in the photocatalyst coating liquid is (1000/100) or less.

6. The photocatalyst coating liquid according to claim 1, wherein a ratio of the photocatalyst particle relative to the photocatalyst coating liquid is 0.1 wt % or more and 1.5 wt % or less.
